(19) United States
(12) Patent Application Publication
(10) Pub. No.: US 2025/0356142 A1
(43) Pub. Date: Nov. 20, 2025

(54) METHOD, APPARATUS, DEVICE AND STORAGE MEDIUM FOR PROCESSING SPEECH CONTENT

(71) Applicants: Beijing Zitiao Network Technology Co., Ltd., Beijing (CN); Lemon Inc., Grand Cayman (KY)

(72) Inventors: Lelai DENG, Beijing (CN); Kang WANG, Beijing (CN); Xudong LIU, Beijing (CN); Ruyun LI, Beijing (CN); Yuanzhe CHEN, Beijing (CN); Yuanyuan HUO, Beijing (CN); Zhuo CHEN, Los Angeles, CA (US); Yuping WANG, Beijing (CN)

(21) Appl. No.: 19/206,131

(22) Filed: May 13, 2025

(30) Foreign Application Priority Data
May 14, 2024 (CN) 202410599292.9

(51) Int. Cl. G06F 40/58; G10L 13/08; G10L 21/028; G10L 25/57; G10L 25/60; G11B 27/031

(52) U.S. Cl. CPC G06F 40/58; G10L 13/08; G10L 21/028; G10L 25/57; G10L 25/60; G11B 27/031

(57) ABSTRACT

A method, an apparatus, a device, and a storage medium for processing speech content are provided. First speech content associated with a target object from target speech content is determined, and the first speech content corresponding to the first text. A second text corresponding to the first text is generated, the first text corresponds to a first language, and the second text corresponds to a second language. Based on at least one segment of the target speech content associated with the target object, a speech feature representation corresponding to the target object is determined. Based on the speech feature representation and a text feature representation of the second text, second speech content corresponding to the second text is generated.

### CROSS REFERENCE

This application claims priority to Chinese Application No. 202410599292.9, filed on May 14, 2024, and entitled “METHOD, APPARATUS, DEVICE AND STORAGE MEDIUM FOR PROCESSING SPEECH CONTENT”, the entirety of which is incorporated herein by reference.

### FIELD

Example embodiments of the disclosure generally relate to the field of computers, and in particular, to a method, an apparatus, a device, and a computer-readable storage medium for processing speech content.

### BACKGROUND

In the field of video production, a demand exists for translation and dubbing of audio in video content across languages. The translation and dubbing of audio across languages may be referred to as “translation and dubbing”. At present, the translation and dubbing task is usually completed manually, which has the advantage of ensuring the quality and accuracy of the translation and dubbing. However, manual translation and dubbing has detects such as high cost, and a relatively low working efficiency.

### SUMMARY

In a first aspect of the disclosure, a method for processing speech content is provided. The method may include: determining first speech content associated with a target object from target speech content, the first speech content corresponding to the first text; generating a second text corresponding to the first text, the first text corresponding to a first language, and the second text corresponding to a second language; determining, based on at least one segment of the target speech content associated with the target object, a speech feature representation corresponding to the target object; and generating, based on the speech feature representation and a text feature representation of the second text, second speech content corresponding to the second text.

In a second aspect of the disclosure, an apparatus for processing speech content is provided. The apparatus may include: a first speech content determining module configured to determine first speech content associated with a target object from target speech content, the first speech content corresponding to a first text; a second text converting module configured to generate a second text corresponding to the first text, the first text corresponding to a first language, and the second text corresponding to a second language; a speech feature representation determining module configured to determine, based on at least one segment of the target speech content associated with the target object, a speech feature representation corresponding to the target object; and a second speech content generating module configured to generate, based on the speech feature representation and a text feature representation of the second text, second speech content corresponding to the second text.

In a third aspect of the disclosure, an electronic device is provided. The device includes at least one processor; and at least one memory coupled to the at least one processor and storing instructions for execution by the at least one processor. The instructions, when executed by the at least one processor, cause the electronic device to perform the method of the first aspect.

In a fourth aspect of the disclosure, a computer-readable storage medium is provided. The medium has a computer program stored thereon, and the computer program, when executed by a processor, implements the method of the first aspect.

It should be understood that the content described in this section is not intended to limit the key features or major features of the embodiments of the disclosure, nor is it intended to limit the scope of the disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the disclosure may be implemented;

FIG. 2 illustrates a flowchart of a method for processing speech content according to some embodiments of the disclosure;

FIG. 3 illustrates an example diagram for a process of processing speech content according to some embodiments of the disclosure;

FIG. 4 illustrates a schematic diagram of an association relationship between a speech feature representation and a text feature representation of a second text according to some embodiments of the disclosure;

FIG. 5 illustrates a schematic diagram of a second language content generation principle according to some embodiments of the disclosure;

FIG. 6 illustrates a schematic structural block diagram of a device for processing speech content according to some embodiments of the disclosure; and

FIG. 7 illustrates a block diagram of an electronic device in which one or more embodiments of the disclosure may be implemented.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms, and should not be construed as being limited to the embodiments set forth herein, but rather, these embodiments are provided for a more thorough and complete understanding of the disclosure. It should be understood that the drawings and embodiments of the disclosure are for illustrative purposes only and are not intended to limit the scope of the disclosure.

In the description of the embodiments of the disclosure, the terms “including” and the like should be understood to inclusively contain, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Herein, unless explicitly stated, “in response to A” performs one step and does not mean that this step is performed immediately after “A”, but may include one or more intermediate steps.

It may be understood that the data involved in the technical solution (including but not limited to the data itself, obtaining, using, storing or deleting of the data) should follow the requirements of the corresponding laws and regulations and related regulations.

It can be understood that, before using the technical solutions disclosed in the embodiments of the disclosure, the types, usage scope, usage scenario and the like of information related to the disclosure should be notified to relevant users in an appropriate manner according to the relevant laws and regulations, and authorized by the relevant users, wherein the relevant users may include any type of rights holders, such as individuals, enterprises, and groups.

For example, in response to receiving an active request from a user, prompt information is sent to the relevant user to explicitly prompt the relevant user that the operation requested to be performed will need to obtain and use the information of the relevant user, so that the relevant user can autonomously select whether to provide information to software or hardware such as the electronic device, application, server, storage medium and the like executing the operation of the technical solution of the disclosure according to the prompt information.

As an optional but non-limiting implementation, in response to receiving an active request of the relevant user, a manner of transmitting prompt information to the relevant user may be, for example, a pop-up window, and prompt information may be presented in a text manner in the pop-up window. In addition, the pop-up window may further carry a selection control for the user to select “agree” or “not agree” to provide information to the electronic device.

It may be understood that the foregoing notification and a process of obtaining a user authorization are merely illustrative, and do not constitute a limitation on implementations of the disclosure, and other manners of meeting related laws and regulations may also be applied to implementations of the disclosure.

As used herein, the term “model” may learn an association relationship between respective inputs and outputs from training data such that a corresponding output may be generated for a given input after training is complete. The generation of the model may be based on machine learning techniques. Deep learning is a machine learning algorithm that processes inputs and provides corresponding outputs by using a multi-layer processing unit. The neural network model is one example of a deep learning-based model. As used herein, a “model” may also be referred to as a “machine learning model”, a “learning model”, a “machine learning network”, or a “learning network”, which terms are used interchangeably herein.

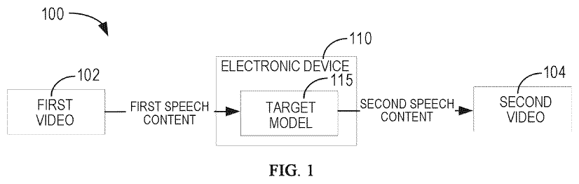

FIG. 1 illustrates a schematic diagram of an example environment 100 in which embodiments of the disclosure may be implemented. As shown in FIG. 1, the environment 100 may include an electronic device 110.

The electronic device 110 may obtain a first video 102. Audio content and silent video content are obtained by splitting the first video 102. The audio content includes target speech content. In this case, the target speech content may be speeches spoken by different characters in the first video 102. In addition, the electronic device 110 may directly obtain the target speech content. For example, the target speech content directly obtained may be a radio drama, an audiobook, or the like. Taking the first video 102 received by the electronic device 110 as an example, the electronic device 110 processes the first video 102 by invoking a target model 115. Illustratively, processing of the target model 115 may include identifying first speech content of each target object in the first video, that is, identifying a speech of each target object. For example, with an example of translating and dubbing the speech spoken by the target object from Chinese to English, a first language corresponds to Chinese and a second language corresponds to English. The target model 115 translates a first text in Chinese corresponding to the first speech content to obtain a second text in English. Thereafter, the target model 115 may determine a speech feature representation of each target object through target language content. Finally, for each target object, second speech content of the target object is generated based on the speech feature representation of the target object and a feature representation of the translated second text (that is, the speech to be spoken by the target object) associated with the target object. The second speech content is the English speech content of the target object. The speech content corresponding to each target object is integrated according to the sequence in the target speech content, to obtain new target speech content composed of the second speech content. If the electronic device 110 receives a radio drama, an audio book, or the like in Chinese, the new target language content is the radio drama, the audiobook, or the like with an English dialogue. If the electronic device 110 receives the Chinese first video 102, it is also necessary to combine the new target language content with a silent video of the first video to obtain the second video 104 with the English dialogue. The above example of translating and dubbing from Chinese into English is merely an example description, there may be any different language during actual translation and dubbing.

The electronic device 110 may, for example, utilize the trained target model 115 to perform a task of processing speech content. The target model 115 may include, but is not limited to, any suitable model such as a translation model, a speech discrimination model, and a text to speech model. The target model 115 may be a model local to the electronic device 110, or may be a model installed on other electronic devices 110 (for example, installed in a remote device). It should be noted that the target model 115 may be a single model or may include multiple models. According to an actual scenario, the target model 115 may further include any other suitable model, for example, the target model 115 may further include a model for performing audio and video separation, or the like.

The electronic device 110 may include any computing system having computing capabilities, such as various computing devices/systems, terminal devices, server devices, or the like. The terminal device may be any type of mobile terminal, a fixed terminal, or a portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camera, a positioning device, a television receiver, a radio broadcast receiver, an electronic book device, a game device, or any combination thereof, including accessories and peripherals of these devices, or any combination thereof. The server device may be a standalone physical server, or may be a distributed system or a server cluster composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server device may include, for example, a computing system/server, such as a mainframe, an edge computing node, a computing device in a cloud environment, or the like.

It should be understood that the structures and functions of various elements in the environment 100 are described for illustrative purposes only and do not imply any limitation to the scope of the disclosure.

At present, video platforms are developing rapidly, and for many video creators and content operation platforms, there is a need to translate and dub audio in the video content across languages. The translation and dubbing of audio in the video content across languages may also be referred to simply as speech translation and dubbing.

In recent years, with the continuous development of Text to Speech (TTS) technology, automatic speech translation and dubbing is also possible. A mainstream process for speech translation and dubbing currently involves the following steps: first peeling video and audio out to obtain the audio and the silent video. A text corresponding to the original language is obtained through automatic speech recognition (ASR) technology. Then, the text in the target language is obtained by using a neural machine translation (NMT). Finally, a final translated and dubbed audio is obtained through the text-to-speech technology. A final cross-lingual second video is obtained after the translated and dubbed audio and the silent video are synthesized. However, a problem about how to provide an approximate or consistent presentation effect as the matching audio and the original audio for the translated and dubbed audio cannot be solved in this mainstream solution of translation and dubbing.

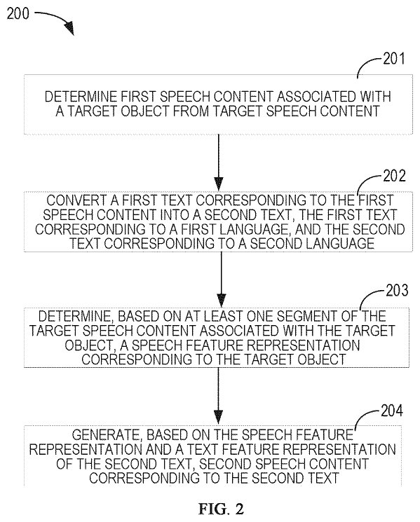

FIG. 2 illustrates an example flow 200 of a method of text detection according to some embodiments of the disclosure. For ease of discussion, the flow 200 will be described with reference to the environment of FIG. 1. The flow 200 relates to stages after the target model 115 is trained, and may be implemented in the electronic device 110.

At block 201, the electronic device 110 determines first speech content associated with a target object from the target speech content, the first speech content corresponding to a first text.

The target speech content may be content determined by the electronic device 110 from the received audio data, or may be content determined from the audio data after the audio data separated by the electronic device 110 from the received first video 102.

Taking the audio data separated from the received first video 102 by the electronic device 110 as an example, the electronic device 110 may first extract audio in the video through an audio and video separation model 301 to obtain the audio data and the silent video. The audio data includes target speech content. To improve the accuracy of subsequent audio processing, the electronic device 110 may also recognize and separate a background sound and a speech in the audio data by using audio processing techniques. Thus, the obtained speech may correspond to the target speech content.

The target speech content may refer to speech spoken by at least one object. The process of processing the speech content may be the same for each object. In the current embodiment, the process of processing the speech content is described by processing speech content of one object as an example, in which the one object may correspond to the target object.

For example, a duration of the target speech content is t, and the target speech content involves two target objects, i.e., a target object A and a target object B. The speech processing of the target object A is described as an example. The electronic device 110 may recognize a plurality of speech content in the target speech content by using a speaking discrimination model 303, so as to determine speech content associated with the target object A and speech content associated with the target object B. All speech content associated with the target object A may be taken as the first speech content. In addition, some related information of the first speech content, for example, duration information of the first speech content, a time occurring in the first video 102, and the like may also be determined.

The recognition logic of the speaking discrimination model 303 is briefly described as follows: first, a feature is extracted from the target speech content, for example, Mel-Frequency Cepstral Coefficients (MFCC), a Power Spectral Density (PSD), a fundamental frequency of sound, or the like. A speaker corresponding to current speech content is determined based on the extracted feature, and then a speaker tag is loaded. Thus, the electronic device 110 may determine the speech content associated with the target object A based on the speaker tag.

At block 202, the electronic device 110 generates a second text corresponding to the first text, the first text corresponding to a first language and the second text corresponding to a second language.

The first speech content may be a plurality of speech segments of the target object, or may be a set of all speech segments of the target object, and a time in which each speech segment appears in the first video 102 may be annotated in the set. The electronic device 110 first converts the first speech content into the first text by using the target model 115.

The first text corresponds to the first language, that is, a language spoken by the target object in the first speech content. In all examples of the disclosure, the first language may be Chinese, and the second language may be English. The languages of Chinese and English are merely illustrative descriptions, and the first language and the second language in the actual scenario may be any two different languages. Then, corresponding to this example, the first text is a Chinese text.

The electronic device 110 translates the first text by using a translation model 302 in the target model 115 to obtain a second text. Corresponding to this example, the Chinese text is translated into English text.

At block 203, a speech feature representation corresponding to the target object is determined based on at least one segment of the target speech content associated with the target object.

The speaking discrimination model 303 may distinguish between speeches of different objects. Based on this, the electronic device 110 may first select the first speech content associated with the target object from the target speech content. That is, the speech of the target object is determined. Further, the first speech content may be screened or intercepted to select the at least one segment. A criterion for screening or intercepting may relate to a clarity, a duration, or the like. The clarity of the speech may be measured based on a signal-to-noise ratio, a speech intensity, a degree of distortion of the speech, or the like. A segment whose duration is within a predetermined duration and whose clarity is not lower than a clarity threshold is selected as the segment associated with the target object. After selecting the segment associated with the target object, the speaking discrimination model 303 may determine the speech feature representation of the target object based on the segment.

At block 204, second speech content corresponding to the second text is generated based on the speech feature representation and a text feature representation of the second text.

FIG. 4 illustrates a schematic diagram of an association relationship 400 between a speech feature representation and a text feature representation of a second text. In the example shown in FIG. 4, n target objects are included, where n is a positive integer. The electronic device 110 may obtain the text feature representation of the second text based on the second text generated by the translation model 302. Based on a recognition result of the speaking discrimination model 303 for each target object, a speech feature representation of each target object may be obtained. The example in FIG. 4 may be represented as a speech feature representation of a target object 1 being associated with a text feature representation 1 of the second text. A speech feature representation of a target object n is associated with a text feature representation n of the second text. When the second speech content corresponding to the second text is generated, it is necessary to be performed based on the text feature representation of the second text and the speech feature representation of the target object. With reference to the foregoing example, if the first text is a Chinese word [symbol] , and the second text may be a word “hello”. The second speech content corresponds to an English word “hello” spoken in a voice of the target object. The feature representation 1 of the second text is associated with the speech feature representation of the target object 1. Taking the target object 1 as an example, a text-to-speech model 304 may generate the second speech content of the target object 1 based on the feature representation 1 of the second text and the speech feature representation of the target object 1.

According to the embodiment of the disclosure, in scenarios such as where it is necessary to translate and dub the target speech content, it is satisfied that the generated second speech content may have an approximate or consistent presentation effect with that of the original first speech content through text translation and extraction of the speech feature representation of the target object. Thus, the automation degree of speech content processing is improved, and the effect after processed is guaranteed.

In some embodiments of the disclosure, determining, by the electronic device 110, the first speech content includes: extracting audio content of a first video; separating the audio content into the target speech content and background audio content; and identifying, from the target speech content, at least one speech segment associated with the target object as the first speech content.

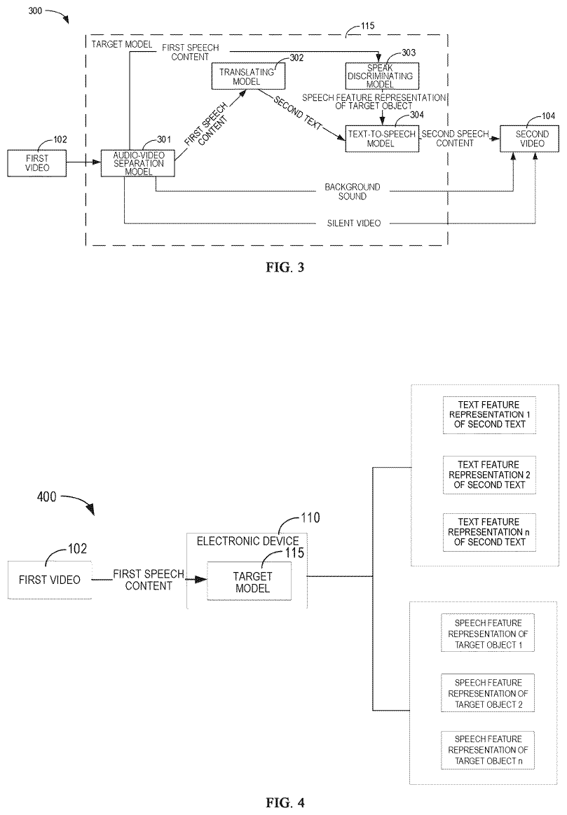

As shown in FIG. 3, the electronic device 110 may first extract the audio content in the first video 102 through the audio and video separation model 301 to obtain audio content and image data. That is, the image data corresponds to a silent video.

Thereafter, the audio and video separation model 301 may further separate the audio content to obtain the target speech content and the background audio content.

The speaking discrimination model 303 performs speaking discrimination on the target speech content, and determines all objects appearing in the target speech content based on the difference between sound features of different objects. In addition, the electronic device 110 may perform speaker differentiation on all the speech content in the target language content by adding a speaker tag. Finally, the speech content with the speaker tag being the target object is determined as the first speech content.

In some embodiments of the disclosure, the electronic device 110 may further obtain image data of the first video; and generate, by combining the image data and the second speech content, a second video corresponding to the second language.

In the scenario of video translation and dubbing, a final objective is to merge the second speech content with the image data of the first video 102 separated from the first video to generate a second video 104 after translated and dubbed. Therefore, when merging, the electronic device 110 may generate the second video 104 corresponding to the second language by combining the image data and the second speech content. It can be understand that if the first video is separated into the target speech content, the background audio content, and the image data during the separation process, the second speech content, the background audio, and the image data are correspondingly combined during merging to obtain the second video 104.

In some embodiments of the disclosure, generating, by the electronic device 110, the second video includes: determining attribute information of the first speech content, the attribute information indicating at least one of the following attributes: volume information, speaking rate information, or time information of the first speech content; and combining, based on the attribute information, the image data and the second speech content to generate the second video.

The determination of the attribute of the first speech content may be obtained after the audio/video separation of the first video is performed at the early stage. For example, after the audio and video are separated, the electronic device 110 may obtain at least one of information of the first speech content, including volume information, speaking rate information, or time information. The time information may correspond to a time when the first speech content appears in the first video, for example, from t1 to t2.

Processing of the speech content is to process the entire speech content extracted from the first video. Therefore, there is usually a plurality of second speech contents. Before the second video 104 is generated, the corresponding second speech content may be adjusted based on the attribute of each first speech content, for example, volume adjustment or speaking rate adjustment. Finally, the adjusted second speech contents are merged according to the time information to form a speech track. The translation and dubbing of the video correspond to merging the speech track with the silent video to obtain the second video 104.

In some embodiments of the disclosure, the electronic device 110 further performs determining an audio quality of each segment associated with the target object, the audio quality indicating at least one of a duration and a signal-to-noise ratio of the segment; and determining, based on the audio quality, at least one segment associated with the target object.

The target speech content usually includes a plurality of segments associated with the target object, and the so-called segment may refer to a sound segment of the target object. When the speech feature representation corresponding to the target object is determined, the plurality of sound segments may be analyzed to determine the audio quality of each sound segment associated with the target object. For example, the signal-to-noise ratio of each sound segment may be detected, so that each sound segment associated with the target object is sorted in descending order of signal-to-noise ratios. In a sorting result, a specified quantity of segments may be selected as the target segment. Alternatively, a segment whose duration is within a predetermined duration range may be selected from the sorting result as the target segment.

In some embodiments of the disclosure, generating, by the electronic device 110, the second text corresponding to the first text includes: processing, by using the first model, the first speech content to generate the second text.

The first model may correspond to the translation model 302 in FIG. 3. The translation model 302 may first convert the first speech content into the first text. For example, Chinese speech content may be converted into a Chinese text. Then, the translation model 302 translates the Chinese text to obtain the second text. As an example, a language of the first text is Chinese and a language of the second text is English, the translation model 302 translates the Chinese text into an English text.

In some embodiments of the disclosure, the second text has a number of syllables corresponding to the first text.

In the process of converting the first text into the second text by using the translation model 302, the electronic device 110 may first determine duration information of the first text. The duration information of the first text may be configured to indicate a syllable duration corresponding to respective text unit in the first text. Taking the first text as a Chinese expression [symbol] as an example, there are a total of 4 text units, and the translation model 302 may determine the syllable duration corresponding to each text unit according to Chinese pronunciation habits. During translation, the translation may be performed according to the duration information of the first text, so that the number of syllables corresponding to the text units in the translated second text is approximate to the number of syllables in the first text, and the syllable duration corresponding to each text unit is also approximate to the syllable duration of the corresponding text unit in the first text.

The approximation may refer to that a difference between a quantity of text units in the second text and a quantity of text units in the first text is within a predetermined quantity difference range. Alternatively, a difference between a syllable duration corresponding to each text unit in the second text and a syllable duration of the corresponding text unit in the first text is within a predetermined duration difference range.

Thus, after being converted into the second speech content, the translated second text is the same as or similar to the first speech content in terms of syllable duration, so that a better performance effect can be achieved when translated and dubbed. In addition, a speaking rate in the first speech content may also be considered during translation. In other words, the translation may be performed by combining information of multiple dimensions such as a speaking rate, a syllable duration, and a syllable quantity, so that the second speech content corresponding to the second text may be aligned with the first speech content during playback.

In some embodiments of the disclosure, generating, by the electronic device 110, the second speech content includes: determining, by using a second model, a feature representation of an expression state of the second speech content; processing, by using a third model, the feature representation of the expression state, the text feature representation of the second text and the speech feature representation to generate an audio sequence; and generating, based on the audio sequence, the second speech content corresponding to the second text.

The second model may be a sub-model of the text-to-speech model 304. The second model may determine the expression state of the second speech content based on the content of the second text. Each category may correspond to one expression state label. For example, the content of the second text is that “Wow, the scenery here is so beautiful”, and the category of the expression state may be a first expression state. For another example, the content of the second text is that “Is the scenery here really as beautiful as people say?”, and the category of the expression state may be a second expression state.

In addition, the second model may further determine the expression state based on an identifier of the target object. The identifier of the target object may be configured to indicate a language preference of the target object, a speaking habit of the target object, or the like. The second model may determine the identifier of the target object through the target speech content. By means of different representations, it may be determined that the expression state corresponds to a different accent. Thus, an expression state label corresponding to the accent may be generated accordingly.

Alternatively, the second model may further determine an expression state of the second speech content by using other speech content associated with the first speech content. For example, after the first speech content is spoken by the target object, another object may say to the target object, i.e., “The way you said this sentence sounds like a foreigner speaking Chinese”. Then, the content spoken by another object may correspond to other speech content associated with the first speech content. Through other speech content, it may be determined that the first speech content has an accent, and accordingly, the expression state label corresponding to the accent may be generated.

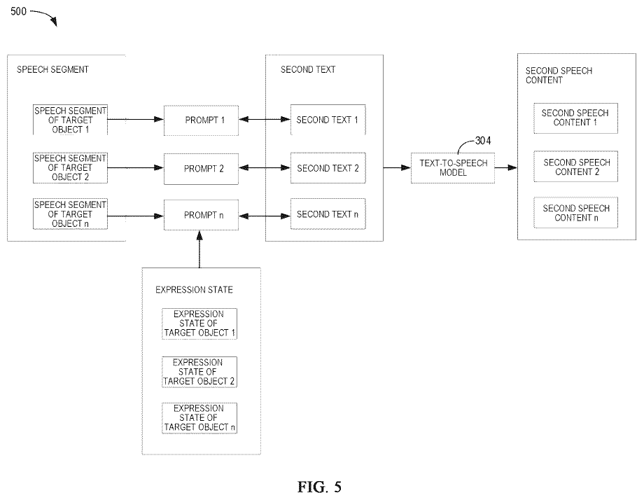

The third model may be a sub-model of the text-to-speech model 304. The third model may be used for generation of an audio sequence. FIG. 5 is a schematic diagram of a generation principle 500 of generation of an audio sequence. Combined with FIG. 5, the third model may be one sub-model in the text-to-speech model 304. The feature representation of the expression state, the feature representation of the second text, and the speech feature representation are input to the third model as prompts, and the third model generates the second speech content according to the prompt and the second text. The feature representation of the expression state may correspond to encoding the expression state to obtain a feature representation of the expression state that may be identified by the third model. Similarly, the feature representation of the second text may correspond to encoding the content of the second text to obtain a feature representation of the second text that may be identified by the third model. A speech feature representation that may be identified by the third model may be obtained by encoding a sound feature of the target object. It can be understood that for each target object, there may be a corresponding prompt. For example, as shown in FIG. 5, n different target objects may be included, the speech feature representation of each target object and the determination process of the prompt may be the same.

For example, the generation process of the second speech content may be that the third model receives the prompt, and first generates a sound feature of a first syllable in the audio sequence. In each subsequent syllable of the audio sequence, the third model generates a sound feature of the current syllable based on the prompt and the sound feature of the previous syllable until a complete audio sequence is generated.

Based on the complete audio sequence, a synthesizer in the text-to-speech model 304 may convert the sound feature of the audio sequence into a corresponding sound waveform, that is, the second speech content. For example, the text-to-speech model 304 may be an autoregressive model.

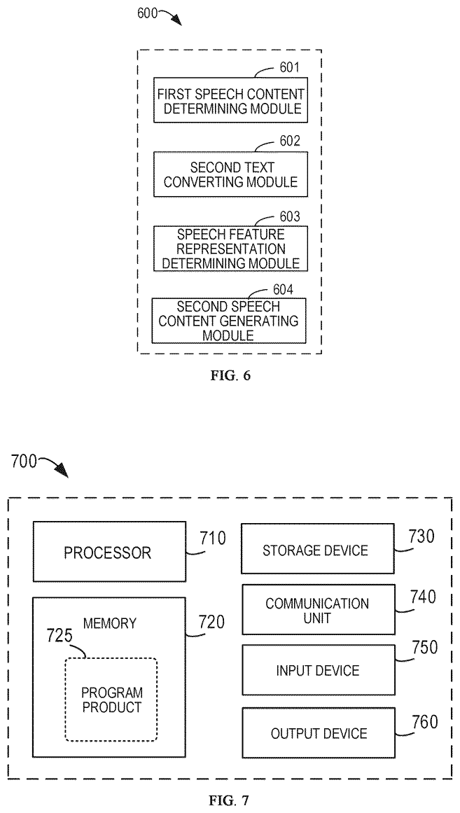

FIG. 6 illustrates a schematic structural block diagram of an apparatus 600 for processing speech content according to some embodiments of the disclosure. The apparatus 600 may be, for example, implemented in or included in the electronic device 110. Various modules/components in the apparatus 600 may be implemented by hardware, software, firmware, or any combination thereof.

As shown, the apparatus 600 includes a first speech content determining module 601 configured to determine first speech content associated with a target object from the target speech content, the first speech content corresponding to the first text; a second text converting module 602 configured to generate a second text corresponding to the first text, the first text corresponding to a first language, and the second text corresponding to a second language; a speech feature representation determining module 603 configured to determine, based on at least one segment of the target speech content associated with the target object, a speech feature representation corresponding to the target object; and a second speech content generating module 604 configured to generate, based on the speech feature representation and a text feature representation of the second text, second speech content corresponding to the second text.

In some embodiments of the disclosure, the first speech content determining module 601 may specifically include: an audio content extracting submodule configured to extract audio content of a first video; an audio content separation submodule configured to separate the audio content into the target speech content and background audio content; and a first speech content determining submodule configured to identify, from the target speech content, at least one speech segment associated with the target object as the first speech content.

In some embodiments of the disclosure, it further includes: an image obtaining module configured to obtain image data of the first video; and a synthesizing module configured to generate, by combining the image data and the second speech content, a second video corresponding to the second language.

In some embodiments of the disclosure, the synthesizing module includes an attribute information determining submodule configured to determine attribute information of the first speech content, the attribute information indicating at least one of volume information, speaking rate information, or time information of the first speech content; and a synthesizing execution submodule configured to combine, based on the attribute information, the image data and the second speech content to generate the second video.

In some embodiments of the disclosure, the speech feature representation determining module 603 may include: an audio quality determining submodule configured to determine an audio quality of each segment associated with the target object, the audio quality indicating at least one of a duration and a signal-to-noise ratio of the segment; and a segment selecting submodule configured to determine, based on the audio quality, at least one segment associated with the target object.

In some embodiments of the disclosure, the second text converting module 602 is specifically configured to process the first speech content by using a first model to generate the second text.

In some embodiments of the disclosure, the second text has a number of syllables corresponding to the first text.

In some embodiments of the disclosure, the second speech content generating module 604 includes: an expression state determining submodule configured to determine, by using a second model, a feature representation of an expression state of the second speech content; an audio sequence generating submodule configured to process, by using a third model, the feature representation of the expression state, the text feature representation of the second text and the speech feature representation to generate an audio sequence; and a second speech content generating submodule configured to generate, based on the audio sequence, the second speech content corresponding to the second text.

FIG. 7 illustrates a block diagram of an electronic device 700 in which one or more embodiments of the disclosure may be implemented. It should be understood that the electronic device 700 illustrated in FIG. 7 is merely illustrative and should not constitute any limitation on the functionality and scope of the embodiments described herein. The electronic device 700 shown in FIG. 7 may include or be implemented as the electronic device 110 of FIG. 1 or the apparatus 600 of FIG. 6.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In a multiprocessor system, a plurality of processing units executes computer-executable instructions in parallel to improve the parallel processing capability of the electronic device 700.

The electronic device 700 generally includes a plurality of computer storage media. Such media may be any available media accessible to the electronic device 700, including, but not limited to, volatile and non-volatile media, and removable and non-removable media. The memory 720 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 730 may be a removable or non-removable medium and may include a machine-readable medium, such as a flash drive, a magnetic disk, or any other medium, which may be capable of storing information and/or data and may be accessed within the electronic device 700.

The electronic device 700 may further include additional removable/non-removable, volatile/non-volatile storage media. Although not shown in FIG. 7, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the disclosure.

The communication unit 740 is configured to communicate with other electronic devices through a communication medium. Additionally, the functionality of components of the electronic device 700 may be implemented in a single computing cluster or multiple computing machines capable of communicating through a communication connection. Thus, the electronic device 700 may operate in a networked environment using logical connections with one or more other servers, network personal computers (PCs), or another network node.

The input device 750 may be one or more input devices, such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed. The external device such as a storage device, a display device, etc., communicates with one or more devices that enable a user to interact with the electronic device 700, or communicates with any device (e.g., a network card, a modem, etc.) that enables the electronic device 700 to communicate with one or more other electronic devices. Such communication may be performed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided. The computer program product is tangibly stored on a non-transitory computer-readable medium and includes computer-executable instructions, and the computer-executable instructions are executed by a processor to implement the method described above.

According to example implementations of the disclosure, a computer program product or a computer program is provided. The computer program product or the computer program includes computer instructions, and the computer instructions are stored in a computer-readable storage medium. A processor of the computer device reads the computer instructions from the computer-readable storage medium, and the processor executes the computer instructions, so that the computer device performs the method provided in the various optional manners in FIG. 2 to FIG. 5, and thus, details are not described herein again.

Aspects of the disclosure are described herein with reference to flowcharts and/or block diagrams of methods, apparatuses, devices, and computer program products implemented in accordance with the disclosure. It should be understood that each block of the flowchart and/or block diagram, and a combination of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by the processing unit of the computer or other programmable data processing apparatus, produce an apparatus to implement the functions/acts specified in the flowchart and/or block diagram. These computer-readable program instructions may also be stored in a computer-readable storage medium, and cause the computer, programmable data processing apparatus, and/or other devices to work in a particular manner, such that the computer-readable medium storing instructions includes an article of manufacture including instructions to implement aspects of the functions/acts specified in the one or more blocks in the flowchart(s) and/or block diagram(s).

The computer-readable program instructions may be loaded onto a computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions/acts specified in one or more blocks in the flowchart(s) and/or block diagram(s).

The flowchart(s) and block diagram(s) in the figures show architecture, functionality, and operation of systems, methods, and computer program products, which may be possibly implemented, according to various implementations of the disclosure. In this regard, each block in the flowchart or block diagram may represent a module, a program segment, or a portion of an instruction that includes one or more executable instructions for implementing the specified logical function. In some alternative implementations, the functions noted in the block(s) may also occur in a different order than that shown in the figures. For example, two consecutive blocks may actually be performed substantially in parallel, which may sometimes be performed in the reverse order, depending on the functionality involved. It is also noted that each block in the block diagram and/or flowchart, as well as a combination of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for processing speech content, comprising:
determining first speech content associated with a target object from target speech content, the first speech content corresponding to a first text;
generating a second text corresponding to the first text, the first text corresponding to a first language, and the second text corresponding to a second language;
determining, based on at least one segment of the target speech content associated with the target object, a speech feature representation corresponding to the target object; and
generating, based on the speech feature representation and a text feature representation of the second text, second speech content corresponding to the second text.

2. The method of claim 1, wherein determining the first speech content associated with the target object from the target speech content comprises:
extracting audio content of a first video;
separating the audio content into the target speech content and background audio content; and
identifying, from the target speech content, at least one speech segment associated with the target object as the first speech content.

3. The method of claim 2, further comprising:
obtaining image data of the first video; and
generating, by combining the image data and the second speech content, a second video corresponding to the second language.

4. The method of claim 3, wherein generating, by combining the image data and the second speech content, the second video corresponding to the second language comprises:
determining attribute information of the first speech content, the attribute information indicating at least one of: volume information, speaking rate information, or time information of the first speech content; and
combining, based on the attribute information, the image data and the second speech content to generate the second video.

5. The method of claim 1, wherein determining, based on the at least one segment of the target speech content associated with the target object comprises:
determining an audio quality of each segment associated with the target object, the audio quality indicating at least one of a duration or a signal-to-noise ratio of the segment; and
determining, based on the audio quality, the at least one segment associated with the target object.

6. The method of claim 1, wherein generating the second text corresponding to the first text comprises:
processing the first speech content by using a first model to generate the second text.

7. The method of claim 6, wherein the second text has a number of syllables corresponding to the first text.

8. The method of claim 1, wherein generating, based on the speech feature representation and the text feature representation of the second text, the second speech content corresponding to the second text comprises:
determining, by using a second model, a feature representation of an expression state of the second speech content;
processing, by using a third model, the feature representation of the expression state, the text feature representation of the second text and the speech feature representation to generate an audio sequence; and
generating, based on the audio sequence, the second speech content corresponding to the second text.

9. An electronic device, comprising:
at least one processor; and
at least one memory coupled to the at least one processor and storing instructions for execution by the at least one processor, the instructions, when executed by the at least one processor, causing the electronic device to perform acts comprising:
determining first speech content associated with a target object from target speech content, the first speech content corresponding to a first text;
generating a second text corresponding to the first text, the first text corresponding to a first language, and the second text corresponding to a second language;
determining, based on at least one segment of the target speech content associated with the target object, a speech feature representation corresponding to the target object; and
generating, based on the speech feature representation and a text feature representation of the second text, second speech content corresponding to the second text.

10. The electronic device of claim 9, wherein determining the first speech content associated with the target object from the target speech content comprises:
extracting audio content of a first video;
separating the audio content into the target speech content and background audio content; and
identifying, from the target speech content, at least one speech segment associated with the target object as the first speech content.

11. The electronic device of claim 10, wherein the acts further comprise:
obtaining image data of the first video; and
generating, by combining the image data and the second speech content, a second video corresponding to the second language.

12. The electronic device of claim 11, wherein generating, by combining the image data and the second speech content, the second video corresponding to the second language comprises:
determining attribute information of the first speech content, the attribute information indicating at least one of: volume information, speaking rate information, or time information of the first speech content; and
combining, based on the attribute information, the image data and the second speech content to generate the second video.

13. The electronic device of claim 9, wherein determining, based on the at least one segment of the target speech content associated with the target object comprises:
determining an audio quality of each segment associated with the target object, the audio quality indicating at least one of a duration or a signal-to-noise ratio of the segment; and
determining, based on the audio quality, the at least one segment associated with the target object.

14. The electronic device of claim 9, wherein generating the second text corresponding to the first text comprises:
processing the first speech content by using a first model to generate the second text.

15. The electronic device of claim 9, wherein generating, based on the speech feature representation and the text feature representation of the second text, the second speech content corresponding to the second text comprises:
determining, by using a second model, a feature representation of an expression state of the second speech content;
processing, by using a third model, the feature representation of the expression state, the text feature representation of the second text and the speech feature representation to generate an audio sequence; and
generating, based on the audio sequence, the second speech content corresponding to the second text.

16. A non-transitory computer-readable storage medium having stored thereon a computer program executable by a processor to perform acts comprising:
determining first speech content associated with a target object from target speech content, the first speech content corresponding to a first text;
generating a second text corresponding to the first text, the first text corresponding to a first language, and the second text corresponding to a second language;
determining, based on at least one segment of the target speech content associated with the target object, a speech feature representation corresponding to the target object; and
generating, based on the speech feature representation and a text feature representation of the second text, second speech content corresponding to the second text.

17. The non-transitory computer-readable storage medium of claim 16, wherein determining the first speech content associated with the target object from the target speech content comprises:
extracting audio content of a first video;
separating the audio content into the target speech content and background audio content; and
identifying, from the target speech content, at least one speech segment associated with the target object as the first speech content.

18. The non-transitory computer-readable storage medium of claim 16, wherein determining, based on the at least one segment of the target speech content associated with the target object comprises:
determining an audio quality of each segment associated with the target object, the audio quality indicating at least one of a duration or a signal-to-noise ratio of the segment; and
determining, based on the audio quality, the at least one segment associated with the target object.

19. The non-transitory computer-readable storage medium of claim 16, wherein generating the second text corresponding to the first text comprises:
processing the first speech content by using a first model to generate the second text.

20. The non-transitory computer-readable storage medium of claim 16, wherein generating, based on the speech feature representation and the text feature representation of the second text, the second speech content corresponding to the second text comprises:
determining, by using a second model, a feature representation of an expression state of the second speech content;
processing, by using a third model, the feature representation of the expression state, the text feature representation of the second text and the speech feature representation to generate an audio sequence; and
generating, based on the audio sequence, the second speech content corresponding to the second text.
